(19) United States
(12) Patent Application Publication
(10) Pub. No.: US 2023/0205910 A1
(43) Pub. Date: Jun. 29, 2023

(54) INFORMATION PROCESSING DEVICE, CONFIDENTIALITY LEVEL DETERMINATION PROGRAM, AND METHOD

(71) Applicant: FUJIFILM Business Innovation Corp., Tokyo (JP)

(72) Inventors: Koki UWATOKO, Kanagawa (JP); Takeshi ZENGO, Kanagawa (JP); Masaki KYOJIMA, Kanagawa (JP); Koichi FUJII, Kanagawa (JP)

(73) Assignee: FUJIFILM Business Innovation Corp., Tokyo (JP)

(21) Appl. No.: 17/993,994

(22) Filed: Nov. 25, 2022

(30) Foreign Application Priority Data
Dec. 23, 2021 (JP) 2021-209960

(51) Int. Cl. G06F 21/62; G06V 30/416

(52) U.S. Cl. CPC G06F 21/6218; G06V 30/416; G06F 2221/2113; G06F 2221/2141

(57) ABSTRACT

An information processing device includes a processor, in which the processor determines a role of each of pages constituting a document, searches each of the pages for a character string indicating a confidentiality level according to different criteria depending on the determined role, and determines a confidentiality level of the document based on a result of the search.

### CROSS-REFERENCE TO RELATED APPLICATIONS

This application is based on and claims priority under 35 USC 119 from Japanese Patent Application No. 2021-209960 filed Dec. 23, 2021.

### BACKGROUND OF THE INVENTION

### (i) Technical Field

The present invention relates to an information processing device, confidentiality level determination-program and method.

### (ii) Related Art

There is known a technique of searching for a character string indicating a confidentiality level described in a document and determining the confidentiality level of the document based on a result of the search.

JP5718630B describes a device that defines a search position and a search pattern and extracts a confidentiality label.

JP4463017B describes a device that determines an image based on arrangement information indicating an arrangement state of a partial image included in a specific image.

Japanese Patent No. 5629908 describes a device that determines whether or not a document is a secure document based on a combination of a plurality of keywords and a positional relation between the plurality of keywords included in the combination.

JP4747591B discloses a device that detects a feature element for each area on a paper surface and determines a category candidate of a document based on the feature element.

By the way, when a character string indicating a confidentiality level is searched for from a document based on a certain criterion regardless of a role of each page constituting the document, the character string indicating a confidentiality level may not be searched for or may be erroneously detected. For example, in a technique of searching for a character string for a certain area of a document regardless of a role of a page, when a character string indicating a confidentiality level is not described in the certain area, it is not possible to search the document for the character string indicating a confidentiality level.

### SUMMARY

An object of the present invention is to more accurately determine a confidentiality level of a document as compared with a case where a character string indicating a confidentiality level is searched for from the document based on a certain criterion regardless of a role of each page constituting the document to determine the confidentiality level of the document.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a processor, in which the processor determines a role of each of pages constituting a document, searches each of the pages for a character string indicating a confidentiality level according to different criteria depending on the determined role, and determines a confidentiality level of the document based on a result of the search.

### BRIEF DESCRIPTION OF THE DRAWINGS

FIG. 1 is a block diagram illustrating functions of a confidentiality determination device.

FIG. 2 is a block diagram illustrating a hardware configuration of the confidentiality determination device.

FIG. 3 is a flowchart illustrating a flow of operation of the confidentiality determination device.

FIG. 4 is a flowchart illustrating a flow of role determination.

FIG. 5 is a diagram illustrating a configuration of a page.

FIG. 6 is a diagram illustrating a body area of a page and a histogram of the number of characters.

FIG. 7 is a diagram illustrating a body area of a page and a histogram of the number of characters.

FIG. 8 is a diagram illustrating a body area of a page and a histogram of the number of characters.

FIG. 9 is a diagram illustrating a body area of a page and a histogram of the number of characters.

FIG. 10 is a diagram illustrating a document having a template structure.

FIG. 11 is a diagram for describing a search area.

FIG. 12 is a diagram for explaining an inclusion relation of character strings.

FIG. 13 is a diagram illustrating a dictionary regarding an inclusion relation of character strings.

FIG. 14 is a flowchart illustrating a flow of processing of searching for a character string by changing a search method according to a role of a page.

### DETAILED DESCRIPTION

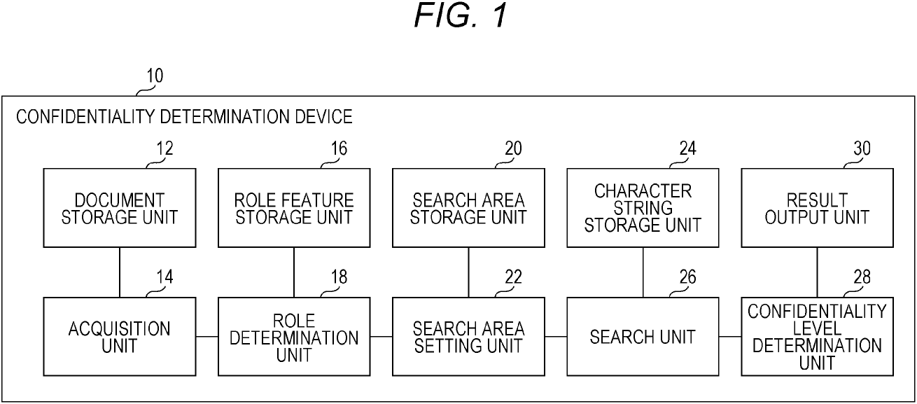

A confidentiality determination device according to an embodiment will be described with reference to FIG. 1. FIG. 1 is a block diagram illustrating functions of a confidentiality determination device 10 according to the embodiment. The confidentiality determination device 10 corresponds to an example of an information processing device.

The confidentiality determination device 10 is a device that determines a confidentiality level of a document indicated by document data.

One or a plurality of characters are expressed in the document, and the document data is data representing such a document. In addition to characters, signs, symbols, figures, drawings, images, or the like other than characters may be expressed in the document. The document data may be of any format. For example, the document data may be data in a text format, data in an image format (for example, BMP format data, JPEG format data, or the like), or data in another format (for example, PDF format data, HTML format data, or the like). The document data for which the confidentiality level is to be determined may be generated by a program that creates document data, or may be generated by digitizing a document (for example, a paper document) as a physical object or converting the document into text. For example, by reading a paper document with a scanner, a camera, or the like, image data representing the document may be generated as document data.

In addition, the document includes one or a plurality of pages. A page is the smallest unit that constitutes a document.

The role of the page is defined. For example, the role of the page is a front cover, a text, an annotation, a chapter title page, a back cover, or the like of the document. These are merely examples of roles, and other roles may be defined. A role of each page may be set by a creator who creates the document or a user who uses the document (for example, a person who views the document).

Also, when the document has a template structure, the role of the page is the body of the document and the template. The body has a role of representing one or a plurality of characters. The template has a role of collectively managing a format (for example, the color and size of characters, the type of font, and the like) of characters represented in the body, a background represented in the body, and the like. One or a plurality of bodies and one template are associated with each other, and editing on the template is reflected in the one or the plurality of bodies associated with the template. For example, when the format or background of the characters set in the template is changed, the contents of the change are reflected in the one or the plurality of bodies associated with the template. As a specific example, when the color of the characters set in the template is changed, the color of the characters represented on the one or the plurality of bodies associated with the template is changed to the changed color.

A template not associated with the body may be included in the document. The template not associated with the body is a template not used for the body. Even when the template is edited, the editing is not reflected in the body. When the template is associated with one or a plurality of bodies and the template is edited, the editing is reflected in the one or the plurality of bodies associated with the template.

For example, a page having a role of the body is associated with information for identifying that the page is the body. A page having a role of the template is associated with information for identifying that the page is the template. The confidentiality determination device 10 refers to the information associated with the page to identify that each page constituting the document is either the body or the template.

A document may represent one or a plurality of characters indicating a confidentiality level of the document. Hereinafter, one or a plurality of characters indicating the confidentiality level will be referred to as a “character string indicating the confidentiality level”. In the present embodiment, the character string indicating the confidentiality level may be constituted by one character or a plurality of characters.

For example, a character string indicating the confidentiality level is displayed on one or a plurality of pages constituting the document.

For example, the character string indicating the confidentiality level is “secret”, “top secret”, “super secret”, “confidential”, “confidential outside a specific section or department of a company”, “confidential outside a company”, or the like. Of course, a character string other than these may be used as the character string indicating the confidentiality level.

The confidentiality level is a concept indicating a degree of confidentiality. For example, the confidentiality level of “top secret” is higher than the confidentiality level of “secret”, and the confidentiality level of “super secret” is higher than the confidentiality level of “top secret”. Of course, the confidentiality level indicated by each character string may be changed by setting the confidentiality level. • • In general, as a document has a higher confidentiality level, the numberof persons who can use the document may be limited, or forms of the use (for example, browsing, copying, and the like) of the document may be limited.

The confidentiality determination device 10 searches the document data for a character string indicating the confidentiality level, and determines the confidentiality level of the document indicated by the document data based on a result of the search. More specifically, the confidentiality determination device 10 determines the role of each of pages constituting the document indicated by the document data, and searches each page for a character string indicating the confidentiality level according to different criteria depending on the determined role. The confidentiality determination device 10 determines the confidentiality level of the document based on a result of the search.

The different criteria according to the role of the page are criteria for searching the page for a character string indicating the confidentiality level, and are, for example, criteria related to a search area according to the role, criteria related to a template, criteria related to a search method, or the like.

The search area is an area in the page in which a character string indicating a confidentiality level is searched for. For example, one or a plurality of search areas are determined in advance for each role of the page. When the criterion related to the search area according to the role is used, the confidentiality determination device 10 searches for a character string indicating the confidentiality level using different search areas according to the role of the page.

The criterion related to the template is to exclude a template that is not used for the body of the document (that is, a template not associated with the body) from a search target of a character string indicating a confidentiality level. When the target document includes a body and a template and the criterion related to the template are used, the confidentiality determination device 10 excludes the template not used for the body of the document from the search target of the character string indicating the confidentiality level, and searches for the character string indicating the confidentiality level from the template (that is, the template associated with the body) used for the body of the document.

The above criterion may be a criterion of excluding a page having the role of the chapter title page from the search target of the character string indicating the confidentiality level.

Each function of the confidentiality determination device 10 will be described below.

A document storage unit 12 stores one or a plurality of pieces of document data. The document storage unit 12 may store one or a plurality of pieces of document data in advance, or may receive and store one or a plurality of pieces of document data output to the document storage unit 12.

An acquisition unit 14 acquires, from the document storage unit 12, document data representing a document for which the confidentiality level is to be determined. Hereinafter, the document for which the confidentiality level is to be determined will be referred to as a “target document”, and the document data representing the target document will be referred to as “target document data”.

For example, the acquisition unit 14 may acquire, from the document storage unit 12, target document data representing a target document designated by a worker such as a user, or may acquire, from the document storage unit 12, document data that meets a predetermined condition (for example, the creation date and time of the document, a creator of the document, the date and time when the document data has been stored in the document storage unit 12, the type of the document, and the like) as target document data.

Note that the confidentiality determination device 10 may not include the document storage unit 12. In this case, the document storage unit 12 is included in an external device (for example, a server or the like) other than the confidentiality determination device 10, and the acquisition unit 14 acquires a document from the external device. For example, the confidentiality determination device 10 and the external device communicate with each other via a communication path such as a local area network (LAN) or the Internet. The acquisition unit 14 acquires a document from the external device via the communication path.

A role feature storage unit 16 stores in advance information indicating the feature of the role of each page. For example, a feature is determined in advance for each role of a page. Hereinafter, the information indicating the feature of the role will be referred to as “role feature information”.

A role determination unit 18 determines the role of each page included in the target document represented by the target document data acquired by the acquisition unit 14 based on the role feature information of each page stored in the role feature storage unit 16.

Note that the confidentiality determination device 10 may not include the role feature storage unit 16. In this case, the role feature storage unit 16 is included in an external device (for example, a server or the like) other than the confidentiality determination device 10, and the role determination unit 18 acquires the role feature information of each page from the external device and determines the role of each page.

For example, the role feature information includes information indicating each of features of a front cover, a text, an annotation, a chapter title page, a back cover, and the like of the document. Specifically, the role feature information includes, for each role (for example, for each front cover, texr, annotation, chapter title page, and back cover), information indicating at least one element among the feature of a layout of the page, the page number, the number of characters described in the page, and the number of sentences described in the page (that is, a set of character strings). The role determination unit 18 determines, based on the role feature information, that each page constituting the target document is any one of a front cover, a text, an annotation, a chapter title page, a back cover, and the like.

For example, the feature of a layout is a distribution (for example, a histogram) of the number of characters in each of a row direction and a coumn direction of the characters in a page. A histogram of the number of characters in each of the row direction and the column direction in the page is defined for each role (for example, for each of a front cover, a text, an annotation, a chapter title page, and a back cover), and the role determination unit 18 specifies a feature of each page based on the histogram of the number of characters in each of the row direction and the column direction in each page constituting the target document, and determines the role of each page.

The role determination unit 18 may determine the role of each page constituting the target document based on the parameters of the model learned using the entire image of each page.

When the target document has a template structure, that is, when the target document includes a body of the document and a template, the role determination unit 18 determines whether each of pages constituting the target document is either of a body or a template. For example, the role determination unit 18 determines that each page is either the body or the template based on information for identifying the body or the template associated with each page.

A search area storage unit 20 stores information indicating a criterion related to the search area according to the role of the page. As described above, one or a plurality of search areas are defined for each role of the page, and the search area storage unit 20 stores, for each role, information indicating the role and information indicating one or a plurality of search areas according to the role in association with each other.

A search area setting unit 22 sets one or a plurality of search areas according to the role of the page in each page in the target document according to the information (that is, information indicating the search area for each role) stored in the search area storage unit 20.

A character string storage unit 24 stores in advance information indicating a plurality of character strings indicating the confidentiality level. For example, the character string indicating the confidentiality level is “secret”, “top secret”, “super secret”, “confidential”, or the like. Of course, a character string other than these may be defined as the character string indicating the confidentiality level. Furthermore, a character string indicating the confidentiality level may be registered in the confidentiality determination device 10 by an operator such as a user. Information indicating the registered character string is stored in the character string storage unit 24.

A search unit 26 searches, for each page of the target document, one or a plurality of search areas set for the page for one or a plurality of character strings indicating the confidentiality level.

A character string group in which character strings indicating the confidentiality level are in a subset relation is determined in advance, and the search unit 26 may search the page for the character string indicating the confidentiality level in order of the length of the character string, and may not search for a shorter character string included in the searched character string from the page. That is, the search unit 26 may search for a longer character string (that is, a character string having a long vocabulary length) first, and may not search for a shorter character string included in the searched character string.

A known technique may be used as a technique of searching for a character string. For example, the character string may be searched using a known character recognition technique.

A confidentiality level determination unit 28 determines the confidentiality level of the target document based on the result of the search by the search unit 26 according to the determination criterion. For example, the search unit 26 searches each page of the target document for one or a plurality of character strings indicating the confidentiality level. The confidentiality level determination unit 28 determines the confidentiality level of the target document based on the one or the plurality of character strings searched from each page.

One example of the determination criterion is a criterion based on the priority of the confidentiality level indicated by the character string. For example, the confidentiality level determination unit 28 determines, as the confidentiality level of the target document, the confidentiality level indicated by the character string indicating the highest priority confidentiality level in the character string group searched by the search unit 26. The priority of each character string indicating the confidentiality level is determined in advance. As described above, for example, the confidentiality level of “top secret” is higher than the confidentiality level of “secret”, and the confidentiality level of “super secret” is higher than the confidentiality level of “top secret”. In this case, the character string “super secret” has the highest priority, the character string “top secret” has the second highest priority, and the character string “secret” has the third highest priority. For example, when the character strings “top secret” and “super secret” are searched, the confidentiality level determination unit 28 determines the confidentiality level indicated by the character string “super secret” having the highest priority among the character strings as the confidentiality level of the target document.

Another example of the determination criterion is a criterion based on the confidentiality level indicated by the most frequent character string. For example, the confidentiality level determination unit 28 may determine, as the confidentiality level of the target document, the confidentiality level indicated by the most frequent character string in the character string group searched by the search unit 26. For example, when five character strings “top secret” are searched, two character strings “secret” are searched, and one character string “super secret” is searched, the confidentiality level determination unit 28 determines the confidentiality level indicated by the character string “top secret” that is the most frequent character string, as the confidentiality level of the target document.

Another example of the determination criterion is a criterion based on the confidentiality level indicated by the character string searched from the front cover. For example, the confidentiality level determination unit 28 may determine, as the confidentiality level of the target document, the confidentiality level indicated by the character string searched for from the page whose role is the front cover. For example, when the character string “secret” is searched for from the front cover by the search unit 26, the confidentiality level determination unit 28 determines the confidentiality level indicated by the character string “secret” as the confidentiality level of the target document.

Another example of the determination criterion is a criterion based on a confidentiality level indicated by a character string searched for from a page other than the front cover. For example, when the search unit 26 does not search for the character string indicating the confidentiality level from the page whose role is the front cover, the confidentiality level determination unit 28 may determine, as the confidentiality level of the target document, the confidentiality level indicated by the character string indicating the highest priority confidentiality level in the character string group indicating the confidentiality level searched for from the page having a role other than the front cover.

As another example, when the search unit 26 does not search for the character string indicating the confidentiality level from the page whose role is the front cover, the confidentiality level determination unit 28 may determine the confidentiality level indicated by the most frequent character string in the character string group indicating the confidentiality level searched from the page having a role other than the front cover as the confidentiality level of the target document.

The above determination criterion may be set in advance in the confidentiality level determination unit 28, or may be set by an operator such as a user.

The result output unit 30 outputs information indicating a result of determination by the confidentiality level determination unit 28. Outputting the information indicating the determination result includes, for example, displaying the information indicating the determination result on a display, transmitting the information to an external device, outputting the information as a voice, and storing the information in a memory.

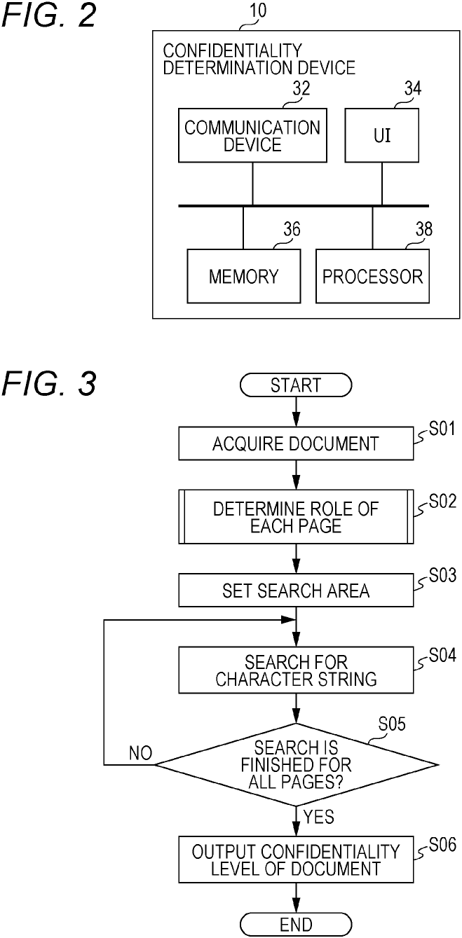

Hereinafter, a hardware configuration of the confidentiality determination device 10 will be described with reference to FIG. 2. FIG. 2 is a block diagram illustrating the hardware configuration of the confidentiality determination device 10.

The confidentiality determination device 10 includes, for example, a communication device 32, a UI 34, a memory 36, and a processor 38.

The communication device 32 is a communication interface including a communication chip and a communication circuit and has a function of transmitting information to another device and a function of receiving information from another device. The communication device 32 may have a wireless communication function or a wired communication function.

The UI 34 is a user interface, and includes a display and an operation device. The display is a liquid crystal display, an EL display, or the like. The operation device is a keyboard, a mouse, an input key, an operation panel, or the like. The UI 34 may be a UI such as a touch panel having both a display and an operation device. The UI 34 may include a microphone and a speaker.

The memory 36 is, for example, a hard disk drive (HDD), a solid- state drive (SSD), various memories (for example, a RAM, a DRAM, a ROM, or the like), other storage devices (for example, an optical disk or the like), or a combination thereof. One or a plurality of memories 36 are included in the confidentiality determination device 10.

The document storage unit 12, the role feature storage unit 16, the search area storage unit 20, and the character string storage unit 24 are constituted by the memory 36. At least one of the document storage unit 12, the role feature storage unit 16, the search area storage unit 20, and the character string storage unit 24 may be provided in an external device instead of being provided in the confidentiality determination device 10.

The processor 38 is configured to control operation of each unit of the confidentiality determination device 10. The processor 38 may have a memory.

The acquisition unit 14, the role determination unit 18, the search area setting unit 22, the search unit 26, and the confidentiality level determination unit 28 are implemented by the processor 38. In the implementation, a memory may be used.

The confidentiality determination device 10 is, for example, a personal computer (hereinafter, referred to as a “PC”), a tablet PC, a smartphone, a mobile phone, a server, or the like.

A user may operate the UI 34 to designate the target document, and the processor 38 may determine a confidentiality level of the designated target document.

As another example, the processor 38 may determine the confidentiality level of the target document in response to an instruction to determine the confidentiality level from a device other than the confidentiality determination device 10. For example, when a user specifies a target document using a terminal device (for example, a PC, a smartphone, or the like), information for identifying the target document and information indicating a determination instruction are transmitted from the terminal device to the confidentiality determination device 10. In response to the instruction, the processor 38 determines a confidentiality level of the target document specified by the user.

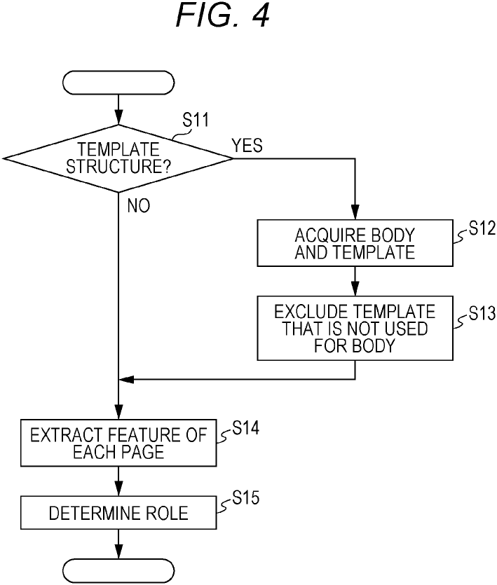

Hereinafter, an operation (that is, a confidentiality level determination method) of the confidentiality determination device 10 will be described with reference to FIGS. 3 and 4. FIG. 3 is a flowchart illustrating a flow of the operation of the confidentiality determination device 10. FIG. 4 is a flowchart illustrating a flow of role determination.

When determining the confidentiality level of the target document, the acquisition unit 14 acquires, from the document storage unit 12, target document data representing the target document for which the confidentiality level is to be determined (S01). The target document may be designated by the user, or even if the user does not designate the target document, the document represented by the document data stored in the document storage unit 12 may be designated as the target document.

Next, the role determination unit 18 determines the role of each page included in the target document represented by the target document data acquired by the acquisition unit 14 based on the role feature information of each page stored in the role feature storage unit 16 (S02). The determination of the role will be described in detail later with reference to FIG. 3.

Next, the search area setting unit 22 sets one or a plurality of search areas according to the role determined in step S02 to each page in the target document according to the information indicating the search area for each role stored in the search area storage unit 20 (S03).

Next, the search unit 26 searches, for each page of the target document, one or a plurality of search areas set for the page in step S03 for one or a plurality of character strings indicating the confidentiality level (S04).

When the search in step S04 is not completed for all the pages included in the target document (S05, No), the processing returns to step S04, and the search by the search unit 26 is performed.

When the search in step S04 is completed for all the pages included in the target document (S05, Yes), the confidentiality level determination unit 28 determines the confidentiality level of the target document based on the result of the search by the search unit 26 according to the determination criterion. The result output unit 30 outputs information indicating the result of the determination by the confidentiality level determination unit 28 (S06). The determination criterion is the criterion described above.

The flow of the role determination performed in step S02 will be described below with reference to FIG. 4.

The role determination unit 18 determines whether the target document has a template structure (S11). That is, the role determination unit 18 determines whether or not the target document is a document including a body and a template.

When the target document has the template structure (S11, Yes), that is, when the target document includes the body and the template, the role determination unit 18 acquires the body and the template from the target document (S12).

Next, the role determination unit 18 excludes a template not used for the body of the target document (that is, a template not associated with the body) from a search target of a character string indicating a confidentiality level (S13). As a result, in step S04, the search unit 26 does not search for a character string indicating the confidentiality level from the page which is the excluded template, and searches for a character string indicating the confidentiality level from the body and the non-excluded template.

Next, the role determination unit 18 extracts a feature of each page constituting the target document (S14). For example, the role determination unit 18 extracts, for each page, at least one of a feature of a layout of the page, a page number, the number of characters described in the page, and the number of sentences described in the page as a feature from the page. The role determination unit 18 does not extract a feature from the template excluded in step S13.

Next, the role determination unit 18 determines the role of each page based on the role feature information of each page stored in the role feature storage unit 16 (S15). For example, the role determination unit 18 determines that each page constituting the target document is any one of a front cover, a text, an annotation, a chapter title page, a back cover, and the like.

When the role of each page is determined, the processing following step S03 illustrated in FIG. 3 is executed.

Hereinafter, a specific example of the embodiment will be described.

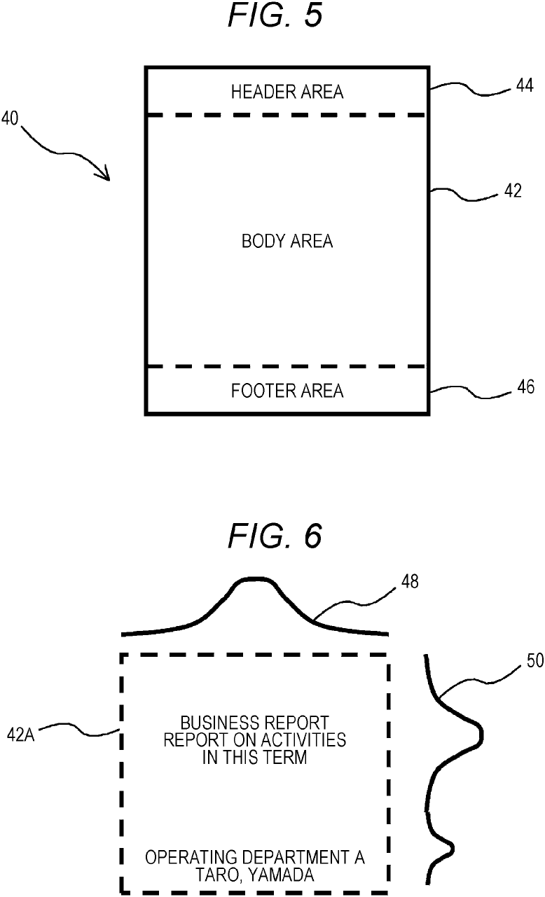

Features used for determining the role of the page will be described. Here, as an example, as illustrated in FIG. 5, a page 40 includes a body area 42, a header area 44, and a footer area 46. The header area 44 is a margin portion at the top of the page 40, and is, for example, an area in which information indicating a title, a creator, a creation date, a correction date, or the like is described. The footer area 46 is a margin portion at the bottom of the page 40, and is, for example, an area in which information indicating a page number or the like is described. Of course, information indicating a title, a creator, or the like may be described in the footer area 46, and information indicating a page number or the like may be described in the header area 44. The body area 42 is an area between the header area 44 and the footer area 46, and is an area where characters, symbols, figures, images, and the like are described.

As described above, in the determination of the role, the feature of a layout of the page, the page number, the number of characters described in the page, the number of sentences described in the page, and the like are used as features of the page. In addition, the total number of pages of the target document may be used as a feature for determining a role. Each feature will be described in detail below.

(1) A page number may be described in each page constituting the target document. Pages 1 to 2 are highly likely to be a front. The role determination unit 18 detects a page number described in each page constituting the target document and determines pages 1 to 2 as a front cover.

(2) When the total number of pages of the target document is one page, that is, when the target document includes one page, there is a high possibility that the page is not a front cover but a text. The role determination unit 18 counts the total number of pages constituting the target document, and when the total number of pages is one page, determines the page as the text.

(3) Depending on the role of the page 40, the total number of characters described in the body area 42 may change. For example, there is a high possibility that the page 40 is a chapter title page, an annotation, a front cover, or a text in the ascending order of the total number of characters described in the body area 42. For example, when the total number of characters in the body area 42 is equal to or less than a first threshold value, there is a high possibility that the page 40 is a chapter title page. When the total number of characters in the body area 42 is larger than the first threshold value and equal to or smaller than a second threshold value (a value larger than the first threshold value), there is a high possibility that the page 40 is an annotation. When the total number of characters in the body area 42 is larger than the second threshold value and equal to or smaller than a third threshold value (a value larger than the second threshold value), there is a high possibility that the page 40 is a front cover. When the total number of characters in the body area 42 is larger than the third threshold value, there is a high possibility that the page 40 is a text.

The role determination unit 18 determines that the page 40 is a chapter title page when the total number of characters is equal to or smaller than the first threshold value, determines that the page 40 is an annotation when the total number of characters is larger than the first threshold value and equal to or smaller than the second threshold value, determines that the page 40 is a front cover when the total number of characters is larger than the second threshold value and equal to or smaller than the third threshold value, and determines that the page 40 is a text when the total number of characters is larger than the third threshold value.

(4) Depending on the role of the page 40, the total number of sentences described in the body area 42 may change. For example, there is a high possibility that the page 40 is a chapter title page, an annotation, a front cover, or a text in the ascending order of the total number of sentences described in the body area 42. For example, when the total number of sentences in the body area 42 is equal to or less than a fourth threshold value, there is a high possibility that the page 40 is a chapter title page. When the total number of sentences in the body area 42 is larger than the fourth threshold value and equal to or smaller than a fifth threshold value (a value larger than the fourth threshold value), there is a high possibility that the page 40 is an annotation. When the total number of sentences in the body area 42 is larger than the fifth threshold value and equal to or smaller than a sixth threshold value (a value larger than the fifth threshold value), there is a high possibility that the page 40 is a front cover. When the total number of sentences in the body area 42 is larger than the sixth threshold value, there is a high possibility that the page 40 is a text.

The role determination unit 18 determines that the page 40 is a chapter title page when the total number of sentences is equal to or smaller than the fourth threshold value, determines that the page 40 is an annotation when the total number of sentences is larger than the fourth threshold value and equal to or smaller than the fifth threshold value, determines that the page 40 is a front cover when the total number of sentences is larger than the fifth threshold value and equal to or smaller than the sixth threshold value, and determines that the page 40 is a text when the total number of sentences is larger than the sixth threshold value. Note that the sentence includes, for example, one or a plurality of characters and has a specific grammatical form (for example, an ending form, a sentence-ending particle, or the like) at the end.

(5) The distribution (for example, a histogram) of the number of characters in each of the row direction and the column direction of the characters in the body area 42 may reflect the role of the page 40. For example, there is a high possibility that a page in which the characters are intensively distributed in the center of the body area 42 is a front cover. There is a high possibility that a page in which the characters are uniformly distributed over the entire body area 42 is a text. The role determination unit 18 calculates a histogram of the number of characters in the body area 42 and determines the role of the page 40 based on the histogram.

Hereinafter, a method of determining the role of the page 40 based on the histogram of the number of characters will be described with reference to FIGS. 6 to 9. FIGS. 6 to 9 illustrate the body area and the histogram of the number of characters. Note that the header area 44 and the footer area 46 may be commonly set for all pages of the target document and thus are excluded from areas from which features are extracted.

FIG. 6 illustrates a body area 42A as a specific example of the body area 42. In addition, a histogram 48 of the number of characters in the row direction and a histogram 50 of the number of characters in the column direction in the body area 42A are illustrated. As indicated by the histogram 48 in the row direction, the characters are intensively distributed in the center of the body area 42A. In this case, the role determination unit 18 determines that a page including the body area 42A has the role of the front cover.

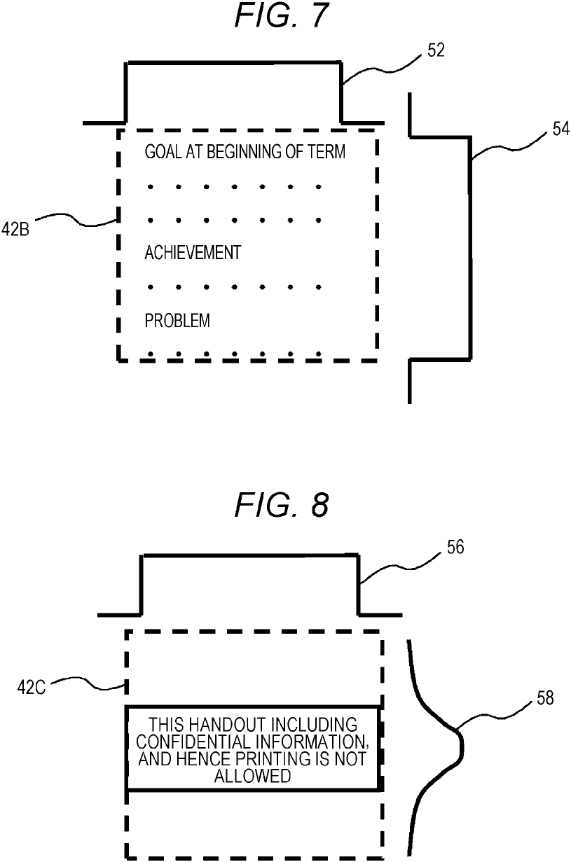

FIG. 7 illustrates a body area 42B as a specific example of the body area 42. In addition, a histogram 52 of the number of characters in the row direction and a histogram 54 of the number of characters in the column direction in the body area 42B are illustrated. As indicated by the histograms 52 and 54, the characters are uniformly distributed in both the row direction and the column direction. In this case, the role determination unit 18 determines that a page including the body area 42B has the role of the text.

FIG. 8 illustrates a body area 42C as a specific example of the body area 42. In addition, a histogram 56 of the number of characters in the row direction and a histogram 58 of the number of characters in the column direction in the body area 42C are illustrated. As indicated by the histogram 56, the characters are uniformly distributed in the row direction, and as indicated by the histogram 58, the characters are intensively distributed in the center of the body area 42C in the column direction. In this case, the role determination unit 18 determines that a page including the body area 42C has the role of the annotation.

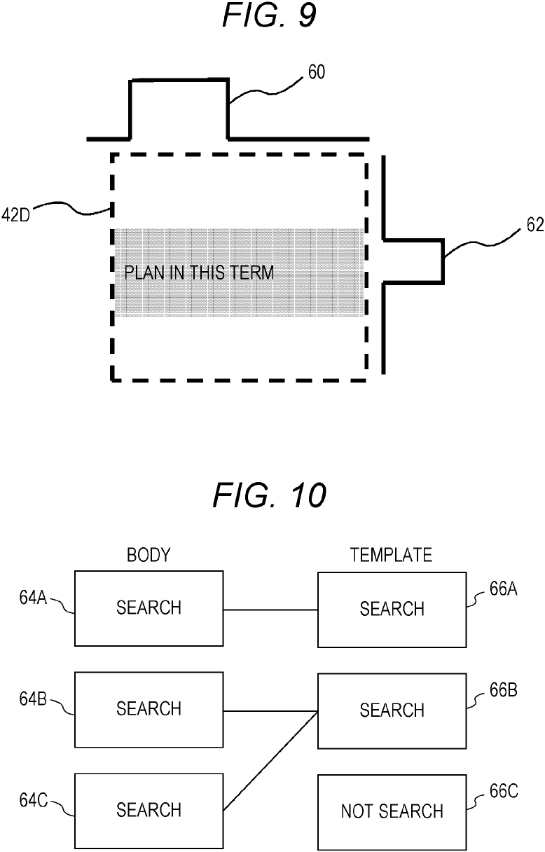

FIG. 9 illustrates a body area 42D as a specific example of the body area 42. In addition, a histogram 60 of the number of characters in the row direction and a histogram 62 of the number of characters in the column direction in the body area 42D are illustrated. As indicated by the histogram 62, the characters are uniformly distributed in the center of the body area 42D in the column direction, and as indicated by the histogram 60, the characters are uniformly distributed in a certain portion in the row direction. In this case, the role determination unit 18 determines that a page including the body area 42D has the role of the annotation.

As illustrated in FIGS. 6 to 9, depending on the role of the page, a difference occurs in a histogram that is a distribution of characters in the page. The role determination unit 18 uses the difference as a feature of the page to determine the role of each page.

The role determination unit 18 may determine the role of the page using any one of the methods (1) to (5) described above, or may determine the role of the page using a plurality of methods among (1) to (5). One or a plurality of methods may be selected from (1) to (5) by a user, and the role determination unit 18 may determine the role of the page according to the one or the plurality of methods selected by a user. The role determination unit 18 may determine the role of the page according to one or a plurality of predetermined methods.

For example, when a plurality of methods among (1) to (5) are used, the role determination unit 18 may determine a criterion for determining a page as a front cover in each of the plurality of methods, and when the criterion is satisfied in each method, 1 may be added to a front cover score of the page for each method to determine a page for which the total of the front cover scores is equal to or greater than a threshold value as a front cover.

A feature in each of the methods (1) to (5) may be quantified, and a classification model using the quantified feature amount group as an explanatory variable may be created in advance by machine learning. The role determination unit 18 may determine the role of the page using the classification model.

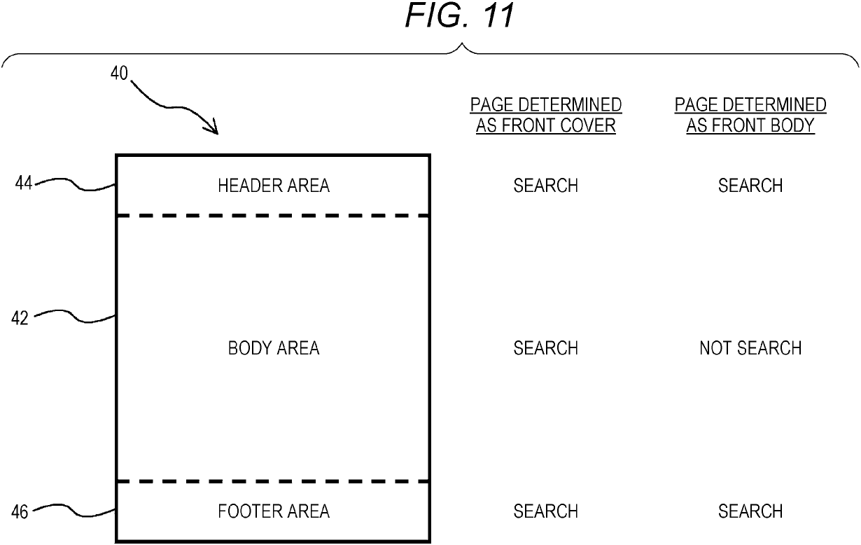

Hereinafter, an example of processing in a case where the target document has a template structure will be described with reference to FIG. 10. FIG. 10 illustrates a body and a template of the target document.

The target document includes bodies 64A, 64B, and 64C and templates 66A, 66B, and 66C.

The template 66A is associated with the body 64A. The template 66B is associated with the bodies 64B and 64C. The template 66 is not associated with the body.

In this case, the template 66C not associated with the body is excluded from the page from which the character string indicating the confidentiality level is searched for. The search unit 26 searches the bodies 64A, 64B, and 64C and the templates 66A and 66B for a character string indicating the confidentiality level.

As a result, even when the character string indicating the confidentiality level is described in the template 66C not associated with the body, it is possible to prevent the confidentiality level of the document from being determined by searching for the character string. That is, it is possible to prevent the confidentiality level of the confidential document from being determined using a template that is not used for the body.

Hereinafter, the search area will be described with reference to FIG. 11. FIG. 11 is a diagram for describing a search area. FIG. 11 illustrates the page 40. The page 40 includes the body area 42, the header area 44, and the footer area 46.

For example, when it is determined that the page 40 is a front cover, the body area 42, the header area 44, and the footer area 46 are set as search areas, and the search unit 26 searches the body area 42, the header area 44, and the footer area 46 for a character string indicating the confidentiality level.

On the other hand, when it is determined that the page 40 is a text, the header area 44 and the footer area 46 are set as search areas, and the body area 42 is not set as a search area. The search unit 26 searches the header area 44 and the footer area 46 for a character string indicating the confidentiality level.

In the front cover, a character string indicating the confidentiality level of the document may be described in any one of the body area 42, the header area 44, and the footer area 46.

Since the header area 44 and the footer area 46 may be commonly set for all pages of the target document, a character string indicating the confidentiality level of the target document may be described in the header area 44 and the footer area 46 also in the text.

On the other hand, a character string indicating the confidentiality level may also be described in the body area 42 of the text. However, there is a high possibility that the character string is not a character string indicating the confidentiality level of the target document but a character string described for explaining in a sentence described in the text. For example, when the character string “top secret” is described in the body area 42 of the text, there is a high possibility that the character string “top secret” is a character string in explanation of a sentence described in the body area 42 of the text, not a character string indicating the confidentiality level of the target document. In order not to search for such a character string, in the text, the body area 42 is excluded from the search area.

As described above, even when the position where a confidentiality label (a character string indicating the confidentiality level) is described changes according to the role of the page, the confidentiality label is extracted and the confidentiality level of the document is determined.

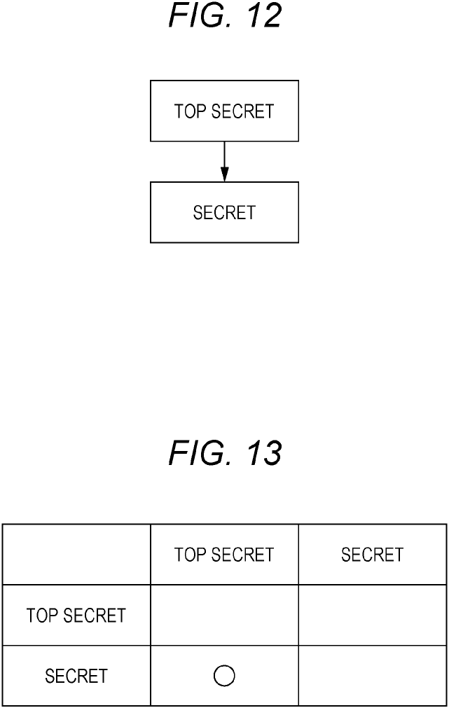

Hereinafter, with reference to FIGS. 12 and 13, a character string group in which character strings indicating a confidentiality level are in a subset relation will be described. FIG. 12 illustrates an inclusion relation of character strings. FIG. 13 illustrates a dictionary regarding an inclusion relationship of character strings.

The search unit 26 may search the page for the character string indicating the confidentiality level in order of the length of the character string, and may not search for a shorter character string included in the searched character string from the page. That is, the search unit 26 may search for a longer character string (that is, a character string having a long vocabulary length) first, and may not search for a shorter character string included in the searched long character string.

With reference to FIG. 12, a subset relationship will be described by taking “top secret” and “secret” as examples.

The character string “secret” is included in the character string “top secret”. That is, the character string “secret” and the character string “top secret” have an inclusion relation.

In the above example, the length of the character string “top secret” (that is, the length of the vocabulary) is the longest, and the length of the character string “secret” is shorter than that of the character string “top secret”.

The search unit 26 searches for a character string indicating the confidentiality level described in the search area in order from a character string having a long vocabulary length. In the above example, the search unit 26 searches for a character string indicating the confidentiality level in the order of the character strings “top secret” and “secret”.

For example, when the character string “top secret” is described in the search area and the search unit 26 searches for the character string “top secret”, the search unit 26 does not search for the character string “secret” having an inclusion relation with the searched character string “top secret” (that is, the shorter character string “secret” included in the searched character string “top secret”). That is, the search unit 26 does not search for the character string “secret”. As a result, a character string having a long vocabulary length (for example, the character string “top secret”) is prevented from being erroneously detected as a character string having a shorter vocabulary length (for example, the character string “secret”). In the examples illustrated in FIGS. 12 and 13, there are two types of character strings having a subset relation (that is, “top secret” and “secret”), but similar processing is executed also in a case where there are three or more types of character strings having a subset relation.

For example, a dictionary representing an inclusion relation of a character string group is created in advance. FIG. 13 illustrates a dictionary representing an inclusion relation of a character string group illustrated in FIG. 12. The symbol “◯” in FIG. 13 indicates that the two character strings have an inclusion relation with each other. The search unit 26 refers to the dictionary to specify the inclusion relationship of the character string group. Note that the information indicating the dictionary may be stored in an external device (for example, a server) other than the confidentiality determination device 10, and the search unit 26 may access the external device and specify the inclusion relationship of the character string group by referring to the dictionary stored in the external device.

In addition, the character string to be searched for may be converted into a regular expression so that the character string is not erroneously detected. For example, when a sentence “This is not confidential” and a character string “confidential” (for example, a character string “confidential” represented by a label) are described in the search area, a search key is converted into regular a expression as described below such that the sentence “This is not confidential” is not searched for and the character string “confidential” is searched for.

### <Regular ExpressionPattern> Confidentiality <Regular Expression Pattern>

The search unit 26 searches for a character string indicating the confidentiality level using the character string converted into a regular expression as a search target.

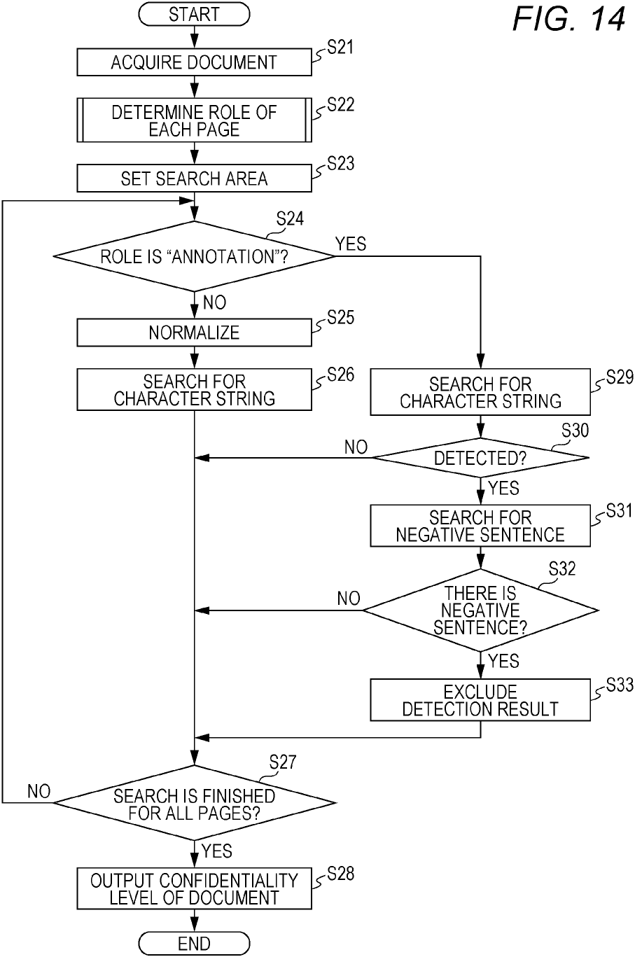

In the above-described embodiment, the confidentiality determination device 10 may change the method of searching for the character string indicating the confidentiality level according to the role of the page. Hereinafter, this processing will be described with reference to FIG. 14. FIG. 14 is a flowchart illustrating a flow of this processing.

The acquisition unit 14 acquires, from the document storage unit 12, target document data representing a target document for which the confidentiality level is to be determined (S21).

Next, as in step S02 described above, the role determination unit 18 determines the role of each page included in the target document represented by the target document data acquired by the acquisition unit 14 (S22).

Next, as in step S03 described above, the search area setting unit 22 sets one or a plurality of search areas according to the role determined in step S22 to each page in the target document (S23).

When the role of the page to be searched is not “annotation” (S24, No), the processing proceeds to step S25. When the role of the page to be searched is “annotation” (S24, Yes), the processing proceeds to step S29.

In the page having the role of “annotation”, it is assumed that the character string indicating the confidentiality level is described in the sentence of the page. On the other hand, in the page having the role of a “front cover”, a “text”, or a “chapter title page”, it is assumed that the character string indicating the confidentiality level is expressed by a label. Therefore, in the processing illustrated in FIG. 14, the search unit 26 searches for a character string indicating the confidentiality level by changing the method of searching for the character string indicating the confidentiality level according to whether or not the role of the page to be searched for is “annotation”. Specifically, the search unit 26 searches for a character string indicating the confidentiality level without using a regular expression for the page having the role of “annotation”. The search unit 26 searches for a character string indicating the confidentiality level for a page having a role other than “annotation” (for example, a page having a role of a “front cover”, a “text”, or a “chapter title page”) by using regular expression. Hereinafter, processings following step S25 will be described.

When the role of the page to be searched for is not “annotation” (S24, No), the character string to be searched for is converted into a regular expression (S25). As described above, for example, an expression such as “<regular expression pattern> confidentiality<regular expression pattern>” is used.

The search unit 26 searches, for each page of the target document, one or a plurality of search areas set for the page in step S23 for one or a plurality of character strings indicating the confidentiality level by using the regular expression described above (S26).

When the search for the character string indicating the confidentiality level is not completed for all the pages included in the target document (S27, No), the processing returns to step S24, and the search by the search unit 26 is performed.

When the search for the character string indicating the confidentiality level is completed for all the pages included in the target document (S27, Yes), the confidentiality level determination unit 28 determines the confidentiality level of the target document based on the result of the search by the search unit 26 according to the determination criterion. The result output unit 30 outputs information indicating a result of determination by the confidentiality level determination unit 28 (S28).

When the role of the age to be searched for is “annotation” (S24, Yes), the search unit 26 searches, for each page of the target document, one or a plurality of search areas set for the page in step S23 for one or a plurality of character strings indicating the confidentiality level without the character string to be searched for into a regular expression (S29).

When the character string indicating the confidentiality level is not detected (S30, No), the processing proceeds to a step S27.

When the character string indicating the confidentiality level is detected (S30, Yes), the search unit 26 searches for whether a negative sentence is described at a back position of the detected character string (S31). The negative sentence is, for example, a sentence such as “is not ....”.

When a negative sentence is not described at a back position of the detected character string and the negative sentence is not searched for (S32, No), the processing proceeds to step S27.

When a negative sentence is described at a position at a back position of the detected character string and the negative sentence is searchedsearched for (S32, Yes), the search unit 26 excludes the character string indicating the confidentiality level, for which the negative sentence has been searched (that is,a character string indicating a confidentiality level, in which the negative sentence is described at the back position), from the detection result of the character string indicating the confidentiality level (S33). That is, the search unit 26 treats the character string of which a negative sentence is described at a back position as not having been detected. In this case, the character string is not used to determine the confidentiality level of the target document. The confidentiality level determination unit 28 determines the confidentiality level of the target document based on the result of the search by the search unit 26 without using the character string. After step S33, the processing proceeds to step S27.

The processing from step S29 to step S33 will be described with a specific example. For example, when a sentence “Confidential information is included in this document” is described in the page to be searched for, the character string “confidential” is detected as the character string indicating the confidentiality level (S29, S30). In this sentence, a negative sentence is not described at a back position of the character string “confidential”, and the negative sentence is not searched for. In this case, the character string “confidential” is not excluded from the detection result.

On the other hand, when a sentence “This document is not confidential” is described in the page to be searched for, the character string “confidential” is detected as the character string indicating the confidentiality level (S29, S30), but the character string “confidential” is excluded fro+D525m the detection result (S32, S33). That is, a negative sentence “is not” is described at a back position of the character string “confidential”, and since the meaning of the sentence “This document is not confidential” is that the document is not confidential, the character string “confidential” is excluded from the detection result.

For example, the search unit 26 uses a regular expression “<regular expression pattern> confidentiality <regular expression pattern> is not <regular expression pattern>” to search a sentence “This document is not confidentia” for a negative sentence. Since a negative sentence “is not” is detected from the sentence, the search unit 26 excludes the character string “confidential” from the detection result.

A plurality of types of negative sentence (for example, a sentence “is not”, a sentence “not included”, and the like) are defined in advance, and the search unit 26 searches for the negative sentence using the definitions.

The above-described function of the confidentiality determination device 10 is implemented by cooperation of hardware and software, for example. For example, the processor reads and executes the program stored in the memory of each device, thereby implementing the function of each device. The program is stored in the memory via a recording medium such as a CD or a DVD, or via a communication path such as a network.

In each of the above embodiments, the processor refers to a processor in a broad sense, and includes a general-purpose processor (for example, CPU: Central Processing Unit, etc.) and a dedicated processor (for example, GPU: Graphics Processing Unit, ASIC: Application Specific Integrated Circuit, FPGA: Field Programmable Gate Array, Programmable Logic Device, etc.). In addition, the operation of the processor in each of the above embodiments may be performed not only by one processor but also by a plurality of processors existing at physically separated positions in cooperation. In addition, the order of each operation of the processor is not limited to the order described in each of the above embodiments, and may be appropriately changed.

What is claimed is:

1. An information processing device comprising a processor,
wherein the processor
determines a role of each of pages constituting a document,
searches each of the pages for a character string indicating a confidentiality level according to different criteria depending on the determined role,
and determines a confidentiality level of the document based on a result of the search.

2. The information processing device according to claim 1,
wherein the role is a body or a template of the document, and
wherein editing to the template is reflected in the body.

3. The information processing device according to claim 2, wherein
the processor excludes a template not used for the body from a search target of a character string indicating a confidentiality level.

4. The information processing device according to claim 1, wherein the role is a front cover, a text, an annotation, or a chapter title page of the document.

5. The information processing device according to claim 4, wherein
the processor determines the role on a basis of at least one of a feature of a layout of a page, a page number, the number of characters described in the page, and the number of sentences described in a page.

6. The information processing device according to claim 5, wherein
the feature of the layout is a distribution of the number of characters in each of a row direction and a column direction in the page.

7. The information processing device according to claim 1 wherein
the processor searches for a character string indicating a confidentiality level using different areas for searching for the character string indicating the confidentiality level, according to the role.

8. The information processing device according to claim 1, wherein a character string group in which character strings indicating a confidentiality level are in a subset relation is determined in advance, and
wherein the processor
searches for a character string indicating a confidentiality level in an order of a length of the character string, and does not search for a shorter character string included in the searched character string.

9. The information processing device according to claim 1, wherein
the processor determines, as a confidentiality level of the document, a confidentiality level indicated by a character string indicating a highest priority confidentiality level in a searched character string group indicating a confidentiality level.

10. The information processing device according to claim 1, wherein
the processor determines, as a confidentiality level of the document, a confidentiality level indicated by a most frequent character string in a searched character string group indicating a confidentiality level.

11. The information processing device according to claim 1, wherein
the processor determines, as a confidentiality level of the document, a confidentiality level indicated by a character string searched for from a page whose role is a front cover.

12. The information processing device according to claim 1, wherein,
when a character string indicating a confidentiality level is not searched for from a page whose role is a front cover, the processor determines, as a confidentiality level of the document, a confidentiality level indicated by a character string indicating a highest priority confidentiality level in a character string group indicating a confidentiality level searched for from a page having a role other than the front cover.

13. The information processing device according to claim 1, wherein,
when a character string indicating a confidentiality level is not searched for from a page whose role is a front cover, the processor determines, as a confidentiality level of the document, a confidentiality level indicated by a most frequent character string in a character string group indicating a confidentiality level searched for from a page having a role other than the front cover.

14. A non-transitory computer-readable recording medium recording a program that causes a computer to operate so as to:
determine a role of each of pages constituting a document;
search each of the pages for a character string indicating a confidentiality level according to different criteria depending on the determined role; and
determine a confidentiality level of the document based on a result of the search.

15. A confidentiality level determination method comprising:
determining a role of each of pages constituting a document;
searching each of the pages for a character string indicating a confidentiality level according to different criteria depending on the determined role; and
determining a confidentiality level of the document based on a result of the search.
